(19) United States
(12) Patent Application Publication
(10) Pub. No.: US 2015/0290962 A1
(43) Pub. Date: Oct. 15, 2015

(54) APPARATUS AND METHOD FOR ARTISTIC WRITING

(71) Applicant: Otto Rodriguez, Miami, FL (US)

(72) Inventor: Otto Rodriguez, Miami, FL (US)

(21) Appl. No.: 14/687,391

(22) Filed: Apr. 15, 2015

Related U.S. Application Data
(60) Provisional application No. 61/979,666, filed on Apr. 15, 2014.

(51) Int. Cl. B43K 8/20; B43K 5/02

(52) U.S. Cl. CPC B43K 8/20; B43K 5/02

(57) ABSTRACT

The present invention is a writing apparatus that is capable of producing a calligraphic line of varying thickness but at a low cost and without requiring the user to have specialized training. The core components of the invention are a hollow tube, a stopper means, a hollow nib, and a roller. These components are configured as follows: a hollow tube with a first opening, a second opening, wherein the hollow tube is filled with ink; a stopper means closing the first opening to prevent ink from escaping the tube from the first opening; a hollow nib with a first end, a body, and a second end where the first end is insert-mated to the second opening of the hollow tube such that the ink may flow from the tube, through the nib first end, and into the nib body; a roller that is cylindrical is rotatably constrained in relation to the hollow nib second end such that the roller may freely rotate along its central axis, at the same time leaving behind the intended lines and constrained as to maintain a gap between the roller body and the nib so that ink may flow from the nib body, coat the roller, and exit the apparatus as the roller rotates about its axis. The invention can be used to produce stylized writing that is usually seen in calligraphy without the difficulty of using existing calligraphy pen designs as they are known in the art.

### CROSS-REFERENCE TO RELATED APPLICATIONS

This U.S. Non-Provisional Patent Application claims the benefit of the currently Pending, U.S. Provisional Patent Application No. 61/979,666, filed on 15 Apr. 2014, and is incorporated by reference as if fully set forth herein.

### FIELD OF THE INVENTION

This invention relates generally to the field of writing instruments, and, more particularly, to an original, different and simpler method and apparatus, achieving the same artistic writing without having had any kind of previous training or practice, nor even having a natural ability to write artistically.

### BACKGROUND

For many centuries, calligraphic writing has had aesthetic value in many societies. The use of specialized pens and nibs and the expertise required to achieve pleasing results has made modern use of calligraphic writing difficult to achieve by the non-practiced scribe. Many people would like to be able to write with a calligraphic style line but without having to use special calligraphic pens or much practice.

It would, therefore, be desirable to have a writing instrument that produces a calligraphic line but through the use of an easy to use and inexpensive apparatus. Therefore, there currently exists a need in the industry for a writing instrument that is capable of producing a calligraphic line of varying thickness, styles and appearances but at a low cost and without requiring the user to have specialized training.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY

The present invention is directed to an apparatus that satisfies the need for a writing instrument that is capable of producing a calligraphic line of varying thickness but at a low cost and without requiring the user to have specialized training.

With respect to the apparatus, embodiments thereof provide for a writing instrument, which comprises the following components: a hollow tube with a first opening, a second opening, wherein the hollow tube is filled with ink; a stopper means closing the first opening to prevent ink from escaping the tube from the first opening; a hollow nib with a cylindrical first end, a body, and a second end where the cylindrical first end is insert-mated to the second opening of the hollow tube such that the ink may flow from the tube, through the nib first end, and into the nib body; a roller with a first end, a second end, a body, and a central axis, wherein said roller is substantially cylindrical or completely cylindrical, with length longer than diameter, rotatably constrained in relation to the hollow nib second end such that the roller may freely rotate along its central axis, at the same time leaving behind the intended lines, constrained within the hollow nib, and where a portion of the roller body protrudes past the hollow nib second end, said roller body sized such as to maintain a gap between the roller body and the nib so that ink may flow from the nib body, coat the roller, and exit the apparatus as the roller rotates about its axis.

Certain embodiments of the present invention may be used for, but not limited to, depositing ink onto a substrate in widths of varying thicknesses based upon the orientation of the apparatus to the direction of movement. It is contemplated, however, that use of certain embodiments of the present invention in other applications beyond writing instruments, is within the scope of the present invention. For example, an embodiment of the present invention may be used to deposit fluids in varying widths onto a substrate.

Embodiments of the present invention may include components manufactured from various materials based upon the contemplated use. Metals such as steel, stainless steel, or aluminum, and plastics such as nylon or ABS may be used. Furthermore, the roller component may be made of, or coated with, a porous or semi-porous material.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a front view, in accordance with an embodiment of the present invention, showing a calligraphy writing apparatus utilizing a completely cylindrical roller.

FIG. 2 is a front view, in accordance with an embodiment of the present invention, showing a hollow nib.

FIG. 3 is a front view, in accordance with an embodiment of the present invention, showing a roller that is substantially cylindrical.

FIG. 4 is a front view, in accordance with an embodiment of the present invention, showing a roller that is completely cylindrical.

FIG. 5 is a front, cross-sectional view, in accordance with an embodiment of the present invention, showing a hollow nib with a substantially cylindrical roller placed within.

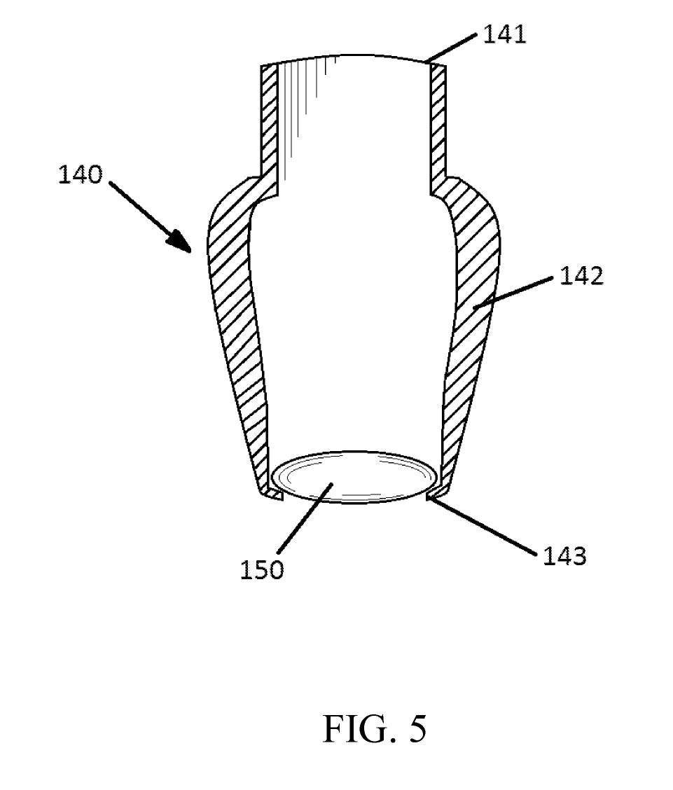

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C but also one or more other components or structures.

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

While the specification will conclude with claims defining the features of embodiments of the invention that are regarded as novel, it is believed that the invention will be better understood from a consideration of the following description in conjunction with the figures, in which like reference numerals are carried forward.

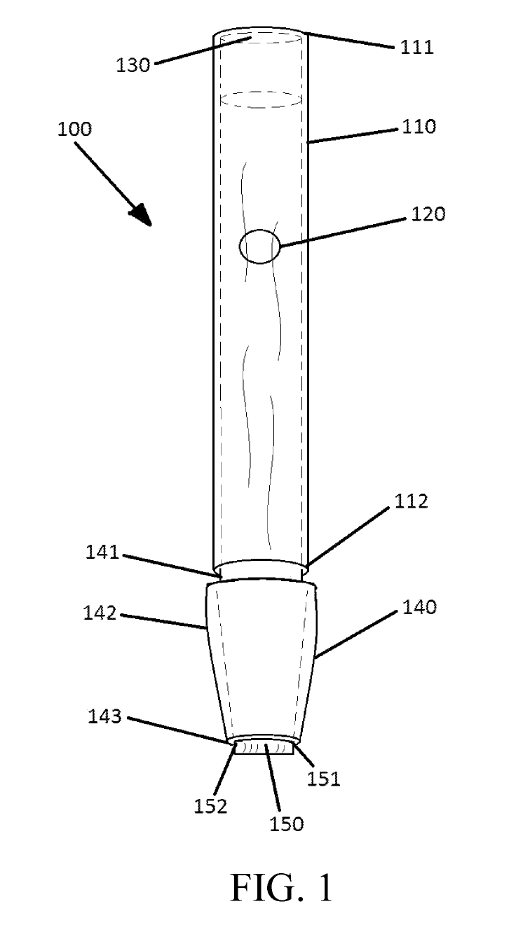

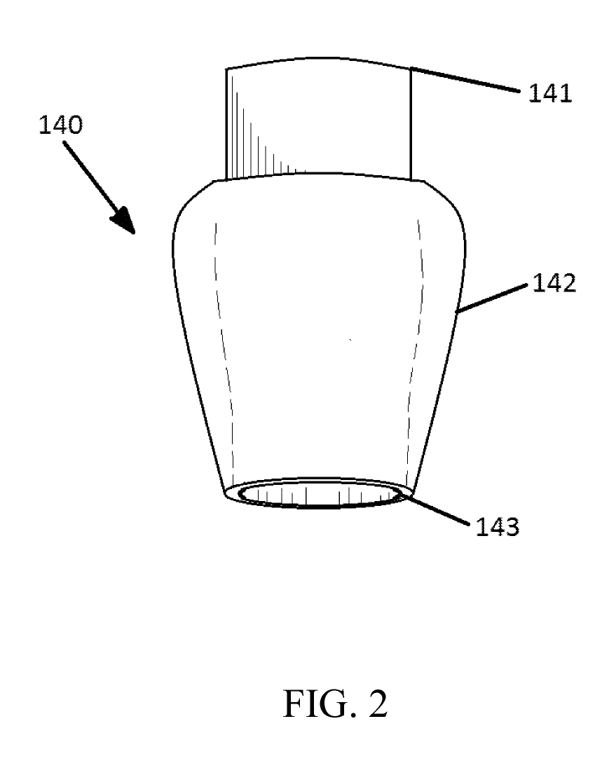

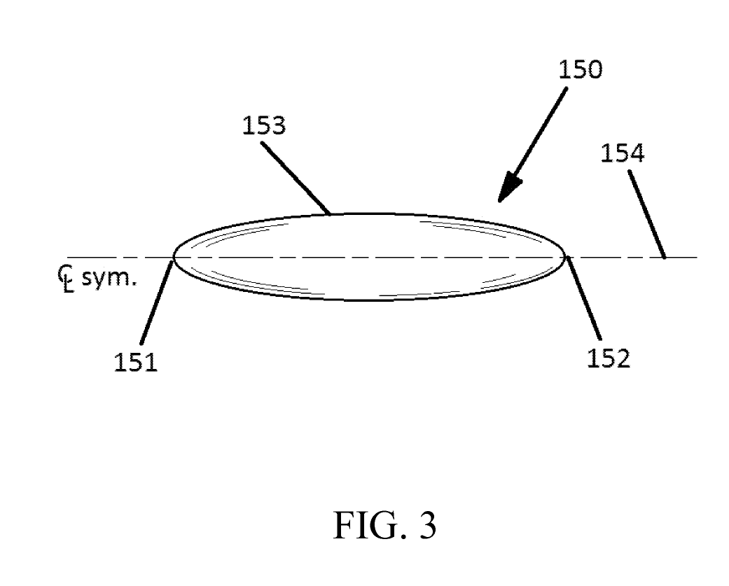

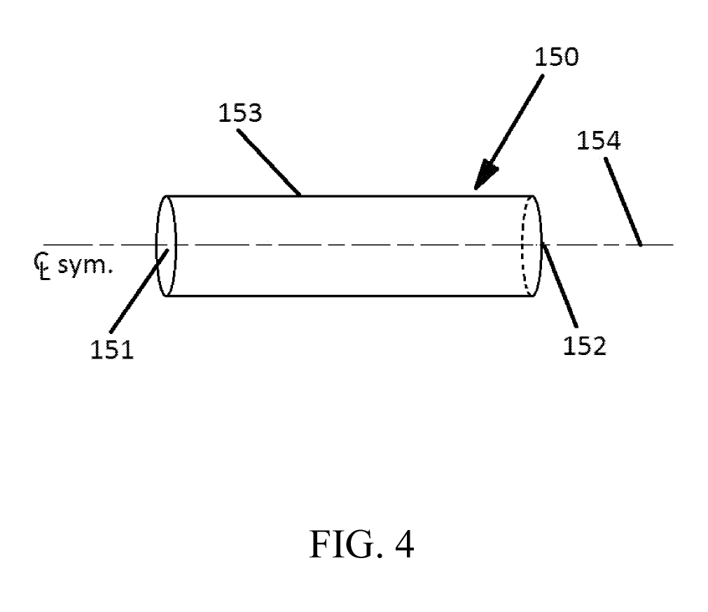

Referring particularly to FIG. 1, and generally to FIGS. 2, 3, and 4, a preferred embodiment of the present invention is in the form of an apparatus 100, which may comprise: a hollow tube 110 with a first opening 111, a second opening 112, wherein the hollow tube is filled with ink 120; a stopper means 130 closing the first opening to prevent ink 120 from escaping the tube 110 from the first opening 111; a hollow nib 140 with a cylindrical first end 141, a body 142, and a second end 143 where the cylindrical first end 141 is insert-mated to the second opening 112 of the hollow tube 110 such that the ink 120 may flow from the tube 110, through the nib's first end 141, and into the nib body 142; a roller 150 with a first end 151, a second end 152, a body 153, and a central axis 154, wherein said roller 150 is substantially or completely cylindrical, with length longer than diameter, rotatably constrained in relation to the hollow nib second end 143 such that the roller 150 may freely rotate along its central axis 154, constrained within the hollow nib 140, and where a portion of the roller body 153 protrudes past the hollow nib second end 143, said roller body 153 sized such as to maintain a gap between the roller body 153 and the nib 140 so that ink may flow from the nib body 142, coat the roller 140, and exit the apparatus 100 as the roller 150 rotates about its axis 154.

Embodiments of the present invention may also comprise one or more of the following: the roller may comprise of a porous or semi-porous outer surface such that ink may be deposited even if the apparatus is not being translated in a direction that would cause the roller to rotate about its axis; the apparatus may wet the roller consistently as it rolls, responding to the movements of the hand; it may transfer ink directly or by being in very close proximity; the body of the roller may comprise various longitudinal and axial cross section profiles so as to create different styled lines; the stopper means for containing the ink, gel, or any other fluid, may be any barrier commonly used in the art such as a cotton plug, a plastic plug, a crimp in the tube, or a physical cap.

It is contemplated as part of the present invention that embodiments thereof may employ various manufacturing methods in order to create the various components of the apparatus. Embodiments of the present invention include, but are not limited to: housings that are made from injection molded plastics, cast metals, or machined metals; fasteners that are made from cast, turned, or machined metals, or molded plastics.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. An apparatus, the apparatus comprising:
a tube, substantially hollow and cylindrical in cross-section, with a first opening and a second opening, wherein the tube is configured to be filled with a fluid;
a stopper means closing the first opening to prevent the fluid from escaping the tube from the first opening;
a nib, which is substantially hollow, with a first end, which is substantially cylindrical, a body, and a second end where the first end is insert-mated to the second opening of the tube such that the fluid may flow from the tube, through the first end, and into the nib body;
a roller with a first end, a second end, a body, and a central axis, wherein said roller is substantially cylindrical, with length longer than diameter, rotatably constrained in relation to the second end of the nib such that the roller may freely rotate along its central axis, constrained within the hollow nib, and where a portion of the roller body protrudes past the second end of the nib, said roller body sized such as to maintain a gap between the roller body and the nib so that the fluid may flow from the nib body, coat the roller, and exit the apparatus as the roller rotates about its central axis.

2. The apparatus of claim 1, wherein the roller further comprises a porous outer surface.

3. The apparatus of claim 1, wherein the roller further comprises a semi-porous outer surface.

4. An apparatus, the apparatus comprising:
a tube, substantially hollow and cylindrical in cross-section, with a first opening and a second opening, wherein the tube is configured to be filled with a fluid;
a stopper means closing the first opening to prevent the fluid from escaping the tube from the first opening;
a nib, which is substantially hollow, with a first end, which is substantially cylindrical, a body, and a second end where the first end is insert-mated to the second opening of the tube such that the fluid may flow from the tube, through the first end, and into the nib body;
a roller with a first end, a second end, a body, and a central axis, wherein said roller is substantially cylindrical, with length longer than diameter, rotatably constrained in relation to the second end of the nib such that the roller may freely rotate along its central axis, constrained within the hollow nib, and where a portion of the roller body protrudes past the second end of the nib, said roller body sized such as to maintain a gap between the roller body and the nib so that the fluid may flow from the nib body, coat the roller, and exit the apparatus as the roller rotates about its central axis, and said roller having a porous outer surface.

5. (canceled)

6. (canceled)

7. (canceled)

8. An apparatus, the apparatus comprising:
a tube, substantially hollow and cylindrical in cross-section, with a first opening and a second opening, wherein the tube is configured to be filled with a fluid;
a plastic plug closing the first opening to prevent the fluid from escaping the tube from the first opening;
a nib, which is substantially hollow, with a first end, which is substantially cylindrical, a body, and a second end where the first end is insert-mated to the second opening of the tube such that the fluid may flow from the tube, through the first end, and into the nib body;
a roller with a first end, a second end, a body, and a central axis, wherein said roller is completely cylindrical, with length longer than diameter, rotatably constrained in relation to the second end of the nib such that the roller may freely rotate along its central axis, constrained within the hollow nib, and where a portion of the roller body protrudes past the second end of the nib, said roller body sized such as to maintain a gap between the roller body and the nib so that the fluid may flow from the nib body, coat the roller, and exit the apparatus as the roller rotates about its central axis, and said roller having a semi-porous outer surface.

9. The apparatus of claim 4, wherein the stopper means closing the first opening to prevent the fluid from escaping the tube from the first opening is in the form of a cotton plug.

10. The apparatus of claim 4, wherein the stopper means closing the first opening to prevent the fluid from escaping the tube from the first opening is in the form of a physical cap.

11. The apparatus of claim 4, wherein the stopper means closing the first opening to prevent the fluid from escaping the tube from the first opening is in the form of a crimp in said first opening of the tube.
